(19) United States
(12) Patent Application Publication
(10) Pub. No.: US 2014/0236902 A1
(43) Pub. Date: Aug. 21, 2014

(54) User Data Backup Method and Apparatus

(71) Applicant: BEIJING QIHOO TECHNOLOGY COMPANY LIMITED, Beijing (CN)

(72) Inventors: Yipeng Zhu, Beijing (CN); Hongyi Zhou, Beijing (CN)

(73) Assignee: BEIJING QIHOO TECHNOLOGY COMPANY LIMITED, Beijing (CN)

(21) Appl. No.: 14/347,281

(22) PCT Filed: Sep. 25, 2012
(86) PCT No.: PCT/CN2012/081907

§ 371 Date: Mar. 26, 2014

(30) Foreign Application Priority Data
Sep. 29, 2011 (CN) 201110291775.5
Sep. 29, 2011 (CN) 201110292007.1
Sep. 29, 2011 (CN) 201110297481.3

(51) Int. Cl. G06F 11/14

(52) U.S. Cl. CPC G06F 11/1446
USPC 707/654

(57) ABSTRACT

The invention discloses a user data backup method, comprising: searching a local computer of a user for an editable document; according to a search result, marking the editable document as data with backup requirement; and backing up the data with backup requirement in a storage device on a network side. Also disclosed is another user data backup method, comprising: monitoring a removable storage device connection status of a local computer of a user; if it is detected that a removable storage device is connected to the local computer, marking data in the device as data with backup requirement; and backing up the data with backup requirement in a storage device on a network side. Further disclosed is yet another user data backup method, comprising: monitoring a resource class temporary file generated in a local system; uploading the resource class temporary file to a storage device on a network side; and according to an access requirement of the local system, providing the local system with download of the uploaded resource class temporary file.

### FIELD OF THE INVENTION

The invention relates to the field of computer application technology, and in particular, to a user data backup method and apparatus.

### BACKGROUND OF THE INVENTION

In the field of computer application, data backup is a process in which a copy of all or part of the data sets in a computer is made and copied to other storage position. When a data loss or corruption is caused due to a computer system failure or misoperation, a rapid recovery may be realized with the backed-up data, and at the same time an unnecessary loss can also be avoided. A traditional way of data backup is generally to copy data to other partition of a local disk of a computer, or to copy data to an external storage device. However, such a way of backup is troublesome on the one hand, and on the other hand, a damage easily occurs to the local disk of the computer, which causes the data backed up onto the other partition to be lost. Furthermore, in practical applications, the data of a user may be of a large amount, and dispersively stored at different positions, and many users are often reluctant to manually locate the data and actively back up it, and even some users themselves do not know which data needs to be backed up and when it needs to be backed up. Thus, once an accident happens, a severe loss may be caused to the user.

### SUMMARY OF THE INVENTION

In view of the above problems, the invention is proposed to provide a user data backup method and a corresponding user data backup apparatus which overcome the above problems or at least in part solve the above problems.

According to an aspect of the invention, there is provided a user data backup method, comprising: searching a local computer of a user for an editable document; according to a search result, marking the editable document as data with backup requirement; and backing up the data with backup requirement in a storage device on a network side.

According to another aspect of the invention, there is provided a user data backup apparatus, comprising: a searching unit adapted to searching a local computer of a user for an editable document; a first backup requirement identification unit adapted to marking the editable document as data with backup requirement according to a search result; and a backup unit adapted to backing up the data with backup requirement in a storage device on a network side.

According to yet another aspect of the invention, there is provided a computer program comprising a computer readable code which causes a server to perform the user data backup method according to any of claims 1-4, when said computer readable code is running on the server.

According to still another aspect of the invention, there is provided a computer readable medium storing the computer program as claimed in claim 9 therein.

According to an aspect of the invention, there is provided a user data backup method, comprising: monitoring a removable storage device connection status of a local computer of a user; if it is monitored that a removable storage device is connected to the local computer, marking data in the removable storage device as data with backup requirement; and backing up the data with backup requirement in a storage device on a network side.

According to yet another aspect of the invention, there is provided a user data backup apparatus, comprising: a monitoring unit adapted to monitoring a removable storage device connection status of a local computer of a user; a backup requirement identification unit adapted to marking data in a removable storage device as data with backup requirement, if the monitoring unit monitors that the removable storage device is connected to the local computer; and a backup unit adapted to backing up the data with backup requirement in a storage device on a network side.

According to yet another aspect of the invention, there is provided a computer program comprising a computer readable code which causes a server to perform the user data backup method according to claim 11 or 12, when said computer readable code is running on the server.

According to still another aspect of the invention, there is provided a computer readable medium storing the computer program as claimed in claim 15 therein.

According to an aspect of the invention, there is provided a user data backup method, comprising: monitoring a resource class temporary file generated in a local system; backing up the resource class temporary file in a storage device on a network side; and according to an access requirement of the local system, providing the local system with download of the backed-up resource class temporary file.

According to yet another aspect of the invention, there is provided a user data backup apparatus, comprising: a monitoring unit adapted to monitoring a resource class temporary file generated in a local system; a backup unit adapted to backing up the resource class temporary file in a storage device on a network side; and a download providing unit adapted to providing the local system with download of the backed-up resource class temporary file according to an access requirement of the local system.

According to yet another aspect of the invention, there is provided a computer program comprising a computer readable code which causes a server to perform the user data backup method according to any of claims 17-24, when said computer readable code is running on the server.

According to still another aspect of the invention, there is provided a computer readable medium storing the computer program as claimed in claim 33 therein.

The beneficial effects of the invention lie in that:

For an ordinary user, the type of editable document as private data, such as a word document, an excel document, a picture document, etc., cannot be obtained through a channel such as network download or purchase, etc., and it will be difficult to recover it once lost, and therefore backup of it has a great significance. A scheme of the invention can automatically find out data dispersed at various positions that possibly needs backup to perform a unified backup operation by searching a local computer of a user for an editable document to identify private data of the user, thereby avoiding the trouble of a manual location by the user to perform backup.

In a removable storage device such as a USB flash disk, a mobile phone, etc., is often stored important data or private data of a user. A scheme of the invention can automatically find out data in a removable storage device that possibly needs backup to perform a unified backup operation by way of monitoring the removable storage device connected to a local computer of a user, thereby avoiding the trouble of a manual location by the user to perform backup.

In the course of operation of a computer, many temporary files will be generated, these temporary files are usually invisible to an ordinary user, but there may be recorded information useful to the user therein, for example, a document being edited yet not saved, various content on web pages, etc. Therefore, in some cases, the user does need these temporary files, especially when the user does not perform a normal saving operation due to a factor such as a misoperation or a system failure, etc., the content of a temporary file may be used for data recovery to some extent, and therefore backup of it has a great significance. A scheme provided by the invention automatically backs up a temporary file generated in a local system in a storage device on a network side by way of monitoring the generation of the system temporary file, thereby facilitating the user to recover data after an abnormal situation occurs, so as to avoid or reduce losses.

The above description is merely an overview of the technical solutions of the invention. In the following particular embodiments of the invention will be illustrated in order that the technical means of the invention can be more clearly understood and thus may be embodied according to the content of the specification, and that the foregoing and other objects, features and advantages can be more apparent.

### BRIEF DESCRIPTION OF THE DRAWINGS

Various other advantages and benefits will become apparent to those of ordinary skills in the art by reading the following detailed description of the preferred embodiments. The drawings are only for the purpose of showing the preferred embodiments, and are not considered to be limiting to the invention. And throughout the drawings, like reference signs are used to denote like components. In the drawings:

FIG. 1 shows schematically a flow chart of a first embodiment of a user data backup method according to an embodiment of the invention;

FIG. 2 shows schematically a structural diagram of a first embodiment of a user data backup apparatus according to an embodiment of the invention;

FIG. 3 shows schematically a flow chart of a second embodiment of a user data backup method according to an embodiment of the invention;

FIG. 4 shows schematically a structural diagram of a second embodiment of a user data backup apparatus according to an embodiment of the invention;

FIG. 5 shows schematically a flow chart of a third embodiment of a user data backup method according to an embodiment of the invention;

FIG. 6 shows schematically a structural diagram of a third embodiment of a user data backup apparatus according to an embodiment of the invention;

FIG. 7 shows schematically a block diagram of a server for performing various embodiments of a method according to the invention; and

FIG. 8 shows schematically a storage unit for retaining or carrying a program code implementing various embodiments of a method according to the invention.

### DETAILED DESCRIPTION OF THE INVENTION

In the following the invention will be further described in connection with the drawings and the particular embodiments.

The inventors have found that there is a kind of data in a computer of a user which is private data of the user; a characteristic of such a kind of data is that it cannot be obtained through a channel such as network download or purchase, etc., and it will be difficult to recover it once lost; and the volume of the private data of the user is generally obviously less than that of system backup data, and it is also more suitable for transmission over the current bandwidth-limited network.

In practical applications, the private data of a user may be of a large amount, and dispersively stored at different positions, and many users are reluctant to manually locate the data and back up it, and even some users themselves do not know which data needs to be backed up and when it needs to be backed up. Thus, once an accident happens, a severe loss may be caused to the user.

In order to solve the above problems, an embodiment of the invention provides a user data backup method, which method comprises the following steps:

searching a local computer of a user for an editable document;

according to a search result, marking the editable document as data with backup requirement; and

backing up the data with backup requirement in a storage device on a network side.

The above described method can automatically find out data dispersed at various positions that possibly needs backup to perform a unified backup operation by searching a local computer of a user for an editable document to identify private data of the user, thereby avoiding the trouble of a manual location by the user to perform backup.

For a better understanding of technical solutions in the invention by one skilled in the art, in the following, the technical solutions in embodiments of the invention will be described in detail with reference to the drawings in the embodiments of the invention. Evidently, the described embodiments are just part of the embodiments of the invention, and not all the embodiments. All the other embodiments obtained by one skilled in the art based on the embodiments in the invention should pertain to the protective scope of the invention.

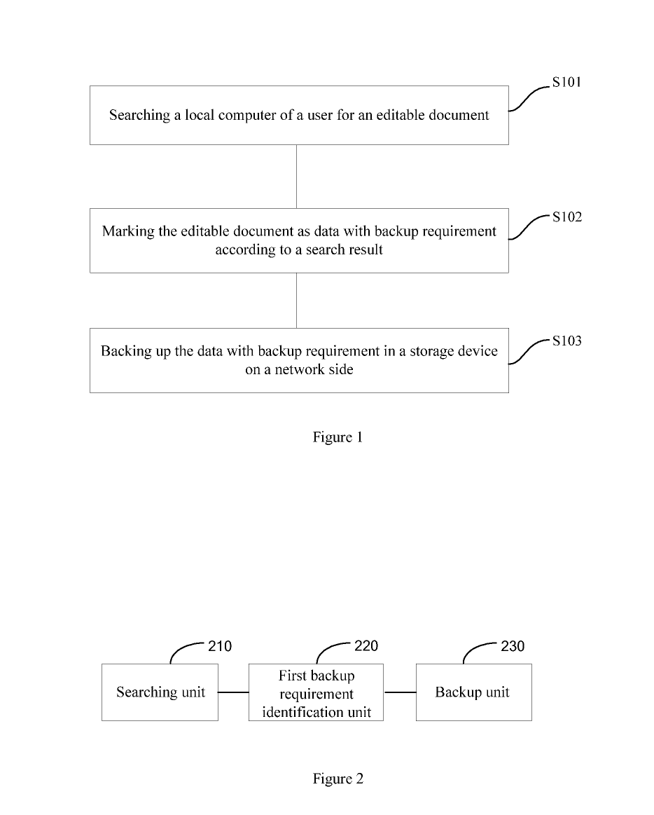

FIG. 1 is a flow chart of a first embodiment of a user data backup method provided by the invention, and the method comprises the following steps.

In S101, searching a local computer of a user for an editable document.

According to a scheme provided by the invention, it is thought that editable documents in the local computer of the user are all data that possibly needs backup. Of course, there are many types of editable documents, and a set of search objects may be predefined according to the use habit of the user, in which set there are comprised some specific types of editable documents, for example, a word document, an excel document that the user often uses. Of course, in applying the scheme of this embodiment, the user may also add an editable document in line with his own use habit according to his own actual need. E.g., the user usually makes an image design or modification, and may define the type of image file he himself often uses in the set of search objects.

In view of that there may be attached some editable documents in an operating system or application software, for example, a software installation protocol, software instructions for use, etc., and that this type of document does not strongly need backup for an ordinary user, therefore, in an embodiment of the invention, some file directories may be precluded so as to avoid a search of these directories for an editable document, e.g., a system directory (windows) in a Windows operating system, an application installation directory (Program Files), etc.

It may be appreciated that for an experienced user, other search directory that needs to be excluded may be set according to an actual need. It may also be possible to specify through a setting that the search is only performed on some specific directories, such as a system desktop directory, a user-specific folder (e.g., “My Documents”), etc., thereby increasing the efficiency of search.

In S102, marking the editable document as data with backup requirement according to a search result.

Editable documents obtained by searching in S101 are all ones that possibly need backup, and in this step, these editable documents may all be marked as data with backup requirement; while in a preferred embodiment of the invention, a plurality of backup requirement identification methods are further provided to implement a further filtering of the search result.

1) Identifying a Backup Requirement According to the Size of an Editable Document

For an editable document, if its content is empty or it contains little content, it may be considered that there is no strong backup requirement for such a document for the user. Therefore, in an embodiment of the invention, an editable document of a document size more than a preset threshold may be marked as data with backup requirement in the search result of S101. Therein, the threshold of the document size may be uniformly set, or may also be set respectively with respect to characteristics of different types of document.

For example, for a newly created excel document, its size is about 10k bytes, but the actual content of the document is empty, and there is no backup requirement. However, for a plain text document or a word document of 10k size, the content it contains is already very much. Based on such a situation, a size threshold may be set respectively with respect to a different type of document. For example, for a text document and a word document, the size of its newly created document is 0 byte; for an excel document, the size of its newly created document is about 10k bytes; and for a ppt document, the size of its newly created document is about 30k bytes. In practical applications, the size threshold of each type of document may be respectively set to be the above values or slightly higher so as to achieve a more accurate identification of the backup requirements of different types of document.

2) Identifying a Backup Requirement According to Whether an Editable Document has been Modified

In some situations, it may be considered that there is a further backup requirement only after a document has been modified. Here, said modification comprises two cases: copy by replacing one file with another one of the same name, or modification by editing with an application. For the above two cases, a way of monitoring whether the size or modification time of a document has been changed may be adopted, and if it has been changed, the document is marked as data with backup requirement. This approach is particularly suitable for an application scenario in which it is further confirmed whether there is a once more backup requirement after an initial backup has already been completed for some documents.

In particular, for the case of modification by the user by editing with an application, the opening and closing operations of a document by the user may be monitored; when the user opens an editable document, the initial size s1 of the document is obtained; when the user closes the document, the size s2 of the document is obtained; and whether the document has been modified may be known by comparing s1 with s2. However, for some specific types of document, e.g., an excel document, modification of some data in a sheet may not lead to a change of the file size. In such a case, whether the user has modified the document may be judged by comparing whether the modification times when the document was opened and when the document was closed have been changed.

3) Identifying a Backup Requirement According to the Frequency of Opening a Document by the User

If the user often performs opening and editing operations on some documents, which shows that the user needs to view the content of these documents or often edits these documents, then it may be considered that these documents have a higher degree of importance, and there is a backup requirement for them. Therefore, for a certain document, the opening operation of the user may be monitored and the frequency of the opening operation may be recorded. If the opening frequency reaches a preset frequency threshold, the document is marked as data with backup requirement. It may be appreciated that in practical applications, the measuring means of the opening frequency may be a total number, for example, it is arranged such that if the total number of opening the document is more than 10, then it is considered that the document has backup requirement; the measuring means may also be an opening number per unit time, for example, it is arranged such that if the number of opening the document during a day is more than 3, then it is considered that the document has backup requirement.

Furthermore, a certain class of editable documents as a whole may also be used as an object to be monitored. For example, the user often edits a plurality of documents under a certain directory, and when the editing frequency of the documents of the whole directory reaches a certain degree, it can be considered that the content contained in this directory is important, and thus all the documents under this directory may be marked data with backup requirement.

In the above there are provided three particular methods for identifying a backup requirement of an editable document, and in practical applications, the three methods may be used independently respectively, or may also be used in combination. Those skilled in the art may further employ other backup requirement identification methods according to actual use requirements, and the invention makes no restriction thereto.

In S103, backing up the data with backup requirement in a storage device on a network side.

In this step, for the data with backup requirement identified in S102, it is backed up through network transmission in a storage device of a server. Therein, this step may be carried out immediately after S101-S102, or may also be carried out independently of S101-S102. For example, after the data with backup requirement is identified, it does not need to be backed up immediately, and a backup operation may be performed when the computer is idle or the network connection status is good. For an editable document with backup requirement, it may be that only a final version of the editable document is backed up, or it may also be that the modification situations of the document are monitored, and different versions of the editable document are backed up in the storage device on the network side, respectively, according to the editing time.

Of course, when this step is particularly implemented, a relevant prompt may be presented to the user before backing up data, to inquire whether the user needs to back up the automatically identified document, and a particular operation is further performed after receiving a confirmation of the user.

Correspondingly to the above method embodiment, the invention also provides a first embodiment of a user data backup apparatus. Referring to FIG. 2, the apparatus may comprise:

a searching unit 210 adapted to searching a local computer of a user for an editable document;

a first backup requirement identification unit 220 adapted to marking the editable document as data with backup requirement according to a search result; and

a backup unit 230 adapted to backing up the data with backup requirement in a storage device on a network side.

Therein, the searching unit 210 may be particularly adapted to searching a local computer of a user for a specific type of editable document.

The first backup requirement identification unit 220 may be particularly adapted to:

marking an editable document of a document size more than a preset threshold as data with backup requirement.

In an embodiment of the invention, the first backup requirement identification unit 220 may be further particularly adapted to:

monitoring whether the size or modification time of a document has been changed, and if it has been changed, marking the document as data with backup requirement.

In an embodiment of the invention, the first backup requirement identification unit 220 may be further particularly adapted to:

monitoring the frequency of opening a document by the user, and if the frequency is greater than a preset threshold, marking the document as data with backup requirement.

Therein, the backup unit 230 may be particularly adapted to:

backing up different versions of an editable document in a storage device on a network side, respectively, according to the editing time; or

backing up only a final version of an editable document in a storage device on a network side.

In the above, the first embodiment of a user data backup method and apparatus provided by the embodiments of the invention is introduced. In the following, a second embodiment of a user data backup method and apparatus provided by the embodiments of the invention is started to be introduced.

In the second embodiment of a user data backup method provided by the embodiments of the invention, the method may comprise the following steps:

monitoring a removable storage device connection status of a local computer of a user;

if it is monitored that a removable storage device is connected to the local computer, marking data in the device as data with backup requirement; and

backing up the data with backup requirement in a storage device on a network side.

The above method can automatically find out data in a removable storage device that possibly needs backup to perform a unified backup operation by way of monitoring the removable storage device connected to a local computer of a user, thereby avoiding the trouble of a manual location by the user to perform backup.

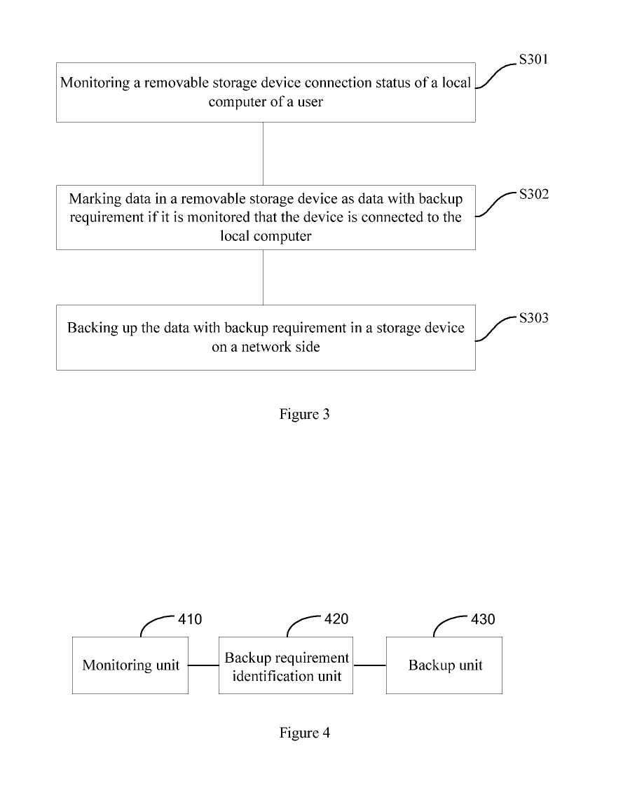

FIG. 3 is a flow chart of the second embodiment of a user data backup method provided by the invention, which method comprises the following steps:

S301, monitoring a removable storage device connection status of a local computer of a user;

S302, if it is monitored that a removable storage device is connected to the local computer, marking data in the device as data with backup requirement; and

S303, backing up the data with backup requirement in a storage device on a network side.

Nowadays, such a device as a USB flash disk, a mobile hard disk, etc. is widely used for file copy between different computers and backup of important data due to portability and mobility thereof. Whereas in such a device as a mobile phone, a digital camera, a voice recording pen, etc. there may be comprised private data of the user such as a photograph taken by the user, recorded video & audio, etc. This type of data cannot be obtained through a channel such as network download or purchase, etc., and it will be difficult to recover it once lost, and therefore backup of it also has a great significance. With respect to the above situation, a scheme provided by the invention is to monitor a removable storage device connection status of a local computer of a user, and once it is found that a removable storage device is connected to the local computer, to mark all the data or part of the data in the device as data with backup requirement and perform a network backup.

For a device such as a mobile phone, a tablet computer, etc., data needing saving comprises a photograph taken by a user, recorded video & audio, etc., and the data is generally saved in a specific folder. According to an embodiment of the invention, some file directories may be preset, and in S302, data located at a specific storage position will be marked as data with backup requirement according to the set content. For an experienced user, also some file directories may be excluded by a setting, for example, a storage directory for system preset backgrounds, ring tones, and map data, an application installation directory, and a download directory, etc. The data in these directories do not strongly need backup for an ordinary user, and thus in S302 the data may not be marked as data with backup requirement.

It may be appreciated that the way of marking data located at a specific storage position in the device as data with backup requirement may similarly be applied to a removable storage device such as a USB flash disk, a mobile hard disk or a digital camera, a voice recording pen, etc.

In addition, it is taken into account that in a removable storage device, data with strong backup requirement has a specific type, e.g., an editable document, an image document or a video and audio recording document, etc. According to an embodiment of the invention, a set of backup requirement identification objects may be predefined, in which set there are comprised some specific types of data, for example, an editable document that the user often uses (a word document, an excel document, a text document, etc.), an image document (jpg, png, etc.), a video recording document (mp4, 3gp, etc.), an audio recording document (way, etc.). In S302, data of a corresponding type in a removable storage device will be marked as data with backup requirement according to the defined set of backup requirement identification objects.

In practical applications, since a removable storage device may be differentiated according to device identification, different content may be defined in the set of backup requirement identification objects for a different type of removable storage device. For example, for a device such as a USB flash disk, a mobile hard disk, etc., only an editable document may be defined in the set; for a device such as a mobile phone, a camera, a voice recording pen, etc., only an image document and a recording document may be defined in the set; whereas for a tablet computer, all the content such as an editable document, an image document, a recording document, etc., may be defined in the set.

It may be appreciated that the above two ways of marking data at a specific storage position as data with backup requirement and marking data of a specific type as data with backup requirement may also be used in combination. For example, in S302, a video document in a videorecording file storage directory in a mobile phone is marked as data with backup requirement, thereby avoiding marking video downloaded by the user from a network as data with backup requirement.

In S303, for the data with backup requirement identified in S302, it is backed up through network transmission in a storage device of a server. Therein, this step may be carried out immediately after S301-S302, or may also be carried out independently of S301-S302. For example, after the data with backup requirement is identified, it does not need to be backed up immediately, but rather, first the identified data is cached into the local computer, and a backup operation does not be performed until the computer system is idle or the network connection status is good.

Correspondingly to the above method embodiment, the invention also provides the second embodiment of a user data backup apparatus. Referring to FIG. 4, the apparatus may comprise:

a monitoring unit 410 adapted to monitoring a removable storage device connection status of a local computer of a user;

a backup requirement identification unit 420 adapted to marking data in a removable storage device as data with backup requirement, if the monitoring unit 410 monitors that the device is connected to the local computer; and

a backup unit 430 adapted to backing up the data with backup requirement in a storage device on a network side.

Therein, the removable storage device may be a mobile terminal, a USB flash disk or a mobile hard disk.

In an embodiment of the invention, the backup requirement identification unit 420 may be particularly adapted to:

marking data located at a specific storage position in the device as data with backup requirement.

In an embodiment of the invention, the backup requirement identification unit 420 may be further particularly adapted to:

marking data of a specific type in the device as data with backup requirement.

In an embodiment of the invention, the backup requirement identification unit 420 may be further particularly adapted to:

marking an editable document, an image document and/or a recording document in the device as data with backup requirement.

In the above, the first embodiment and the second embodiment of a user data backup method and apparatus of the invention are introduced. In the following, a third embodiment of a user data backup method and apparatus of the invention will be introduced.

In the process of a user using a computer, some poor conditions will often occur due to a misoperation or a system failure, etc. For example, a document being edited is not saved correctly, a browser is closed abnormally when browsing a web page, and so on. For ease of recovering data by the user after an abnormal situation occurs, the third embodiment of a user data backup method is further provided by the embodiments of the invention, which method may comprise the following steps:

monitoring a resource class temporary file generated in a local system;

uploading the resource class temporary file to a storage device on a network side; and

according to an access requirement of the local system, providing the local system with download of the uploaded resource class temporary file.

In the process of a user using a computer, many temporary files will be created by a system or an application, in these temporary files is recorded much information useful to the user, and these temporary files may be used for data recovery after an abnormal condition has occurred. However, a temporary file is usually invisible to an ordinary user, and many users even do not know the existence of a temporary file. With respect to the above situation, a method provided by the invention automatically backs up a temporary file generated by a system in a storage device on a network side by way of monitoring the generation of the system temporary file, thereby facilitating the user to recover data after an abnormal situation occurs, so as to avoid or reduce losses.

FIG. 5 is a flow chart of the third embodiment of a user data backup method provided by the invention, and the method comprises the following steps.

In S501, monitoring a resource class temporary file generated in a local system.

In the process of a user using a computer, many temporary files will be created in a local system by the system or an application, e.g., in the process of download, in the process of editing. Additionally, when a user is browsing a website, a browser will also save the cache of a web page in a local system.

Theoretically, it may be considered that all the temporary files generated in a local system are data that possibly needs backup. However, in practical applications, what strongly need backup are those resource class temporary files, e.g., an editable file such as word, excel, etc., a media file such as audio, video, etc., a web page cache file, etc. Therefore, in this step, it may be preferred to select these temporary files of specific types for monitoring.

In a particular implementation process, the monitoring and control of the generation of a temporary file may be realized by monitoring a specific storage position of the temporary file in a system. In the course of operation of a computer, a temporary file may be created at a plurality of positions. Take a Windows operating system as an example, there are comprised three kinds of commonly used temporary folder:

1) System Folder

A Windows operating system dumps a system temporary file with a folder of the path C:\Windows\Temp by default. Generally, users are mostly software of a system service type (e.g., Exchange Server). There is generally little content in such a folder.

2) User Account Temporary Folder

A Windows operating system takes the path C:\Documents and Settings\User Name (e.g., Administrator)\Local Settings\Temp as a temporary folder of a user account by default, which is generally used for an application to dump a temporary file for the purpose of temporary calling and writing. There is generally much content in such a folder.

3) IE Temporary Folder

The default path is C: \Documents and Settings\User Name\Local Settings\Temporary Internet Files, of which the function is to store content of a web page a user recently browsed.

From the functions of the above three kinds of temporary folder, it can be known that more resource class temporary files may be generated in the user account temporary folder and the IE temporary folder, and therefore, in this step, the two folders may be monitored. In view of that some users may modify the path of a temporary folder according to his own use habit, in a scheme provided by the invention, particular paths of these temporary file directories may be obtained by way of reading a system configuration file. Of course, it may also be allowed for a user to manually set a temporary file directory that needs monitoring.

In another embodiment of the invention, also a temporary file generated by a system may be located by way of monitoring the ongoing of a startup behavior of an application. For example, in the course of a user browsing a web page, some documents (e.g., a word, PDF document, etc.) may be opened directly by double clicking on the web page, in which case a browser will first write the document to the local system in the form of a temporary file, and then call a specific application (e.g., Microsoft word, PDF reader, etc.) associated with the format of the document to open the document. As such, for a browser program, it can monitor which applications are triggered to start up in the browser, and in turn a temporary file opened by the application may be particularly located, which temporary file is the data with backup requirement.

In addition to monitoring the startup of an application in a browser program, similarly, also a startup behavior of an application may be monitored in a mail client program, an instant messaging program, and a compression/decompression program, thereby accurately locating the document data with backup requirement.

In S502, uploading the resource class temporary file to a storage device on a network side.

In this step, for the newly generated resource class temporary file monitored in S501, it is backed up through network transmission in a storage device of a server. Therein, this step may be performed automatically, or also a relevant prompt may be presented to the user before backing up data, to inquire whether the user needs to back up these temporary files, and a backup operation is further performed after receiving a confirmation of the user.

In an embodiment of the invention, it may also be possible to further monitor a temporary file already generated, and if it is found that the file has been modified, then the modified file is also uploaded to the storage device on the network side. This scheme is particularly suitable for backing up a file of editable type. In a particular implementation, different modified versions of a temporary file may be respectively periodically uploaded to the storage device on the network side; or also only a final modified version of a temporary file may be uploaded to the storage device on the network side.

In S503, providing the local system with download of the uploaded resource class temporary file according to an access requirement of the local system.

After the temporary file is backed up in the server on the network side, it may be used for data recovery in two situations. One situation consists in that a manual recovery is needed after the user performs a misoperation, and at this time, the user may manually access the storage device on the network side by entering the network address of the storage device on the network side, and find the content previously backed up to download locally. Another situation consists in non-normal shutdown of the system or an application resulting from a system failure, such as a system halt, a browser crash, etc., in which case, according to a scheme of the invention, after the system or application is restarted, an access may be initiated automatically to the storage device on the network side according to the detected non-normal shutdown situation, so as to obtain the content previously backed up.

It may be appreciated that, the storage device on the network side may set a different access right for a different user. When accessing the storage device on the network side, the local system may log in the storage device on the network side by way of e.g., a user name, a password, etc., and after confirming the access right of the local system, the storage device on the network side further provides the local system with download of the resource class temporary file previously uploaded.

In the following, the scheme provided by the invention will be further described in connection with a practical application scenario.

For example, when the user is browsing a web page, he may open some media class files, e.g., audio, video, etc. If the browser suddenly exits abnormally, the user needs to find the web page referencing the video again and enter the web page for viewing. In applying the scheme provided by the invention, when a video or audio file is found to have been written to a temporary folder, the data will be automatically backed up on the network. As such, if the browser exits abnormally, upon a next startup of the browser by the user, the user may be prompted that the video or audio for which viewing was interrupted previously has already been backed up on the network side, and the user may go directly to the memory on the network side to download it for enjoying himself.

In some cases, after the user receives a mail online, he finds that a word document attachment is contained in the mail and then directly opens the document for editing. However, after the user finishes editing and saves, it is often found that the edited document cannot be found. Such a situation occurs actually because the document has not been normally downloaded to the local computer, but rather, a copy of the document has been created in the form of a temporary file in the local computer when the user opened the document from the mail. A similar situation is further comprised in which the user directly opens a document from a file compression package and edits it, and at this time only a copy of the document is created in the form of a temporary file, but not the document in the compression package is directly edited indeed. However, a temporary file will often be cleared away following actions of system restart, browser shutdown, compression software shutdown, etc., and even if it is not cleared away, it is difficult for an ordinary user to find a document he needs, since the number of temporary files is large and the way they are named is different to that of an ordinary file. In view of the above situations, in applying the scheme provided by the invention, a storage position of a temporary file in a system is monitored, or a startup behavior of a specific application is monitored, and once the generation of a temporary file is found, the data will be backed up on a network automatically or semi-automatically (e.g., after obtaining an instruction of the user), such that the user may find a document he needs conveniently.

Furthermore, it may be possible to continue monitoring an editable file already backed up, and if it is found that the file has been modified, then the modified file is also uploaded to the storage device on the network side. In a particular implementation, different modified versions of a temporary file may be respectively periodically uploaded to the storage device on the network side; or also only a final modified version of a temporary file may be uploaded to the storage device on the network side.

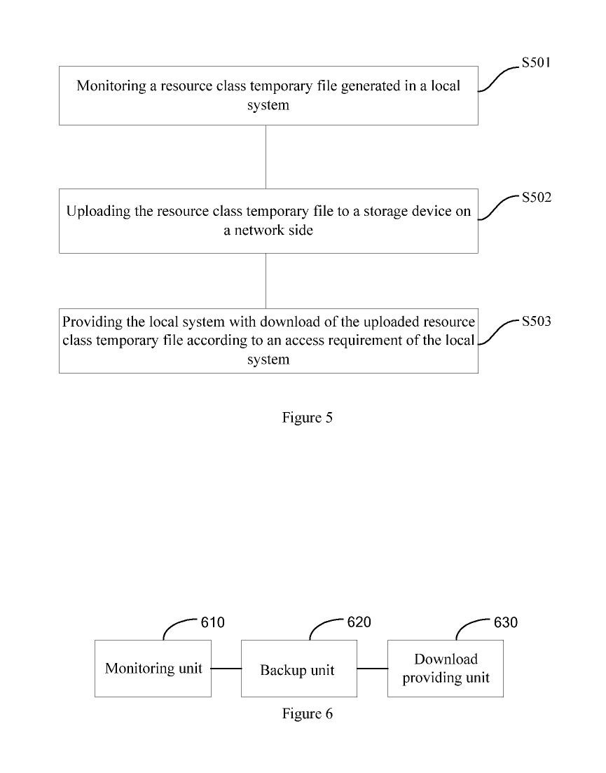

Correspondingly to the above method embodiment, the invention also provides a user data backup apparatus. Referring to FIG. 6, the apparatus may comprise:

a monitoring unit 610 adapted to monitoring a resource class temporary file generated in a local system;

wherein the resource class temporary file may comprise: a media file, an editable file and/or a web page cache file temporarily stored in the local system.

In an embodiment of the invention, the monitoring unit 610 may be particularly adapted to monitoring a specific temporary storage position in the local system and obtaining a resource class temporary file written to the specific temporary storage position; or also be adapted to monitoring a startup behavior of an application and obtaining a resource class temporary file opened after the startup of the application.

The apparatus further comprises:

a backup unit 620 adapted to uploading the resource class temporary file to a storage device on a network side; and

a download providing unit 630 adapted to providing the local system with download of the uploaded resource class temporary file according to an access requirement of the local system.

Therein, the access requirement of the local system may comprise:

access to a network address of the storage device on the network side by the local system, or

detection of a non-normal shutdown of the system or an application resulting from a failure of the local system.

In an embodiment of the invention, the monitoring unit 610 may also be adapted to monitoring whether the temporary file has been modified, and if yes, triggering the backup unit 620 to upload the modified file to the storage device on the network side.

The backup unit 620 may be particularly adapted to:

uploading periodically different modified versions of the temporary file to the storage device on the network side respectively; or

uploading only a final modified version of the temporary file to the storage device on the network side.

The download providing unit 630 may be particularly adapted to:

providing the local system with download of the uploaded resource class temporary file after confirming the access right of the local system, according to an access requirement of the local system.

For ease of description, the above apparatuses are described with respect to functionally divided various units respectively. Of course, when practicing the invention, the functions of the various units may be carried out in the same one or more items of software and/or hardware.

It can be seen from the description of the above embodiments that, the skilled in the art may clearly learn that the invention may be implemented by way of software plus a necessary general-purpose hardware platform. Based on such an understanding, the technical solutions of the invention, substantially or for the part contributing to the prior art, may be embodied in the form of a software product, and the computer software product may be stored in a storage medium, such as ROM/RAM, a magnetic disk, a compact disc, etc., and comprises several instructions for causing a computer device (which may be a personal computer, a server, or a network device, etc.) to perform methods described in various embodiments or certain parts of the embodiments of the invention.

Various embodiments in this specification are all described using a progressive manner, identical or similar parts of various embodiments may be referred relative to each other, and each embodiment highlights its difference from other embodiments. Especially, for an embodiment of an apparatus, it is described relatively simply due to it being substantially similar to a corresponding method embodiment, and as for its relevant parts reference may be made to the parts of the method embodiment. The apparatus embodiments described above are just schematic, wherein units illustrated as separate components may be or also may not be physically separated; and components shown as units may be or also may not be physical units, namely, may be located at one place, or also may be distributed across a plurality of network units. Part or all of the modules therein may be selected according to an actual need to achieve the object of the schemes of the embodiments. They can be understood and effected by those of ordinary skills in the art without paying out creative work.

In the above, various embodiments of a user data backup method and apparatus provided by the invention have been described in detail. Herein, particular examples are applied to set forth the principles and embodiments of the invention, and the description of the above embodiments is just for helping understanding the methods of the invention and core ideas thereof; meanwhile, for those of ordinary skills in the art, there may be changes to a particular embodiment and its application scope. In conclusion, the content of the specification should not be construed as limiting to the invention.

Embodiments of the individual components of the invention may be implemented in hardware, or in a software module running on one or more processors, or in a combination thereof. It will be appreciated by those skilled in the art that, in practice, some or all of the functions of some or all of the components in a user data backup apparatus according to individual embodiments of the invention may be realized using a microprocessor or a digital signal processor (DSP). The invention may also be implemented as a device or an apparatus program (e.g., a computer program and a computer program product) for carrying out a part or all of the method as described herein. Such a program implementing the invention may be stored on a computer readable medium, or may be in the form of one or more signals. Such a signal may be obtained by downloading it from an Internet website, or provided on a carrier signal, or provided in any other form.

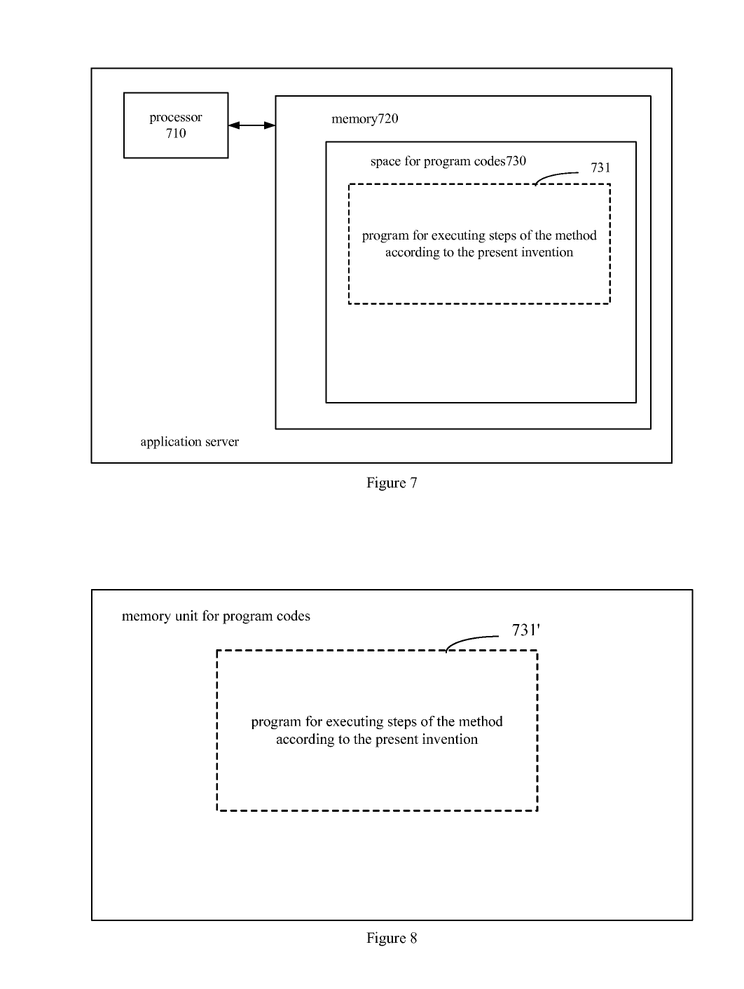

For example, FIG. 7 shows a server which may carry out individual embodiments of a user data backup method according to the invention, e.g., an application server. The server traditionally comprises a processor 710 and a computer program product or a computer readable medium in the form of a memory 720. The memory 720 may be an electronic memory such as a flash memory, an EEPROM (electrically erasable programmable read-only memory), an EPROM, a hard disk or a ROM. The memory 720 has a memory space 730 for a program code 731 for carrying out any method steps in the methods as described above. For example, the memory space 730 for a program code may comprise individual program codes 731 for carrying out individual steps in the above methods, respectively. The program codes may be read out from or written to one or more computer program products. These computer program products comprise such a program code carrier as a hard disk, a compact disk (CD), a memory card or a floppy disk. Such a computer program product is generally a portable or stationary storage unit as described with reference to FIG. 8. The storage unit may have a memory segment, a memory space, etc. arranged similarly to the memory 720 in the server of FIG. 7. The program code may for example be compressed in an appropriate form. In general, the storage unit comprises a computer readable code 731′, i.e., a code which may be read by e.g., a processor such as 710, and when run by a server, the codes cause the server to carry out individual steps in the methods described above.

“An embodiment”, “the embodiment” or “one or more embodiments” mentioned herein implies that a particular feature, structure or characteristic described in connection with an embodiment is included in at least one embodiment of the invention. In addition, it is to be noted that, examples of a phrase “in an embodiment” herein do not necessarily all refer to one and the same embodiment.

In the specification provided herein, a plenty of particular details are described. However, it can be appreciated that an embodiment of the invention may be practiced without these particular details. In some embodiments, well known methods, structures and technologies are not illustrated in detail so as not to obscure the understanding of the specification.

It is to be noted that the above embodiments illustrate rather than limit the invention, and those skilled in the art may design alternative embodiments without departing the scope of the appended claims. In the claims, any reference sign placed between the parentheses shall not be construed as limiting to a claim. The word “comprise” does not exclude the presence of an element or a step not listed in a claim. The word “a” or “an” preceding an element does not exclude the presence of a plurality of such elements. The invention may be implemented by means of a hardware comprising several distinct elements and by means of a suitably programmed computer. In a unit claim enumerating several apparatuses, several of the apparatuses may be embodied by one and the same hardware item. Use of the words first, second, and third, etc. does not mean any ordering. Such words may be construed as naming.

Furthermore, it is also to be noted that the language used in the description is selected mainly for the purpose of readability and teaching, but not selected for explaining or defining the subject matter of the invention. Therefore, for those of ordinary skills in the art, many modifications and variations are apparent without departing the scope and spirit of the appended claims. For the scope of the invention, the disclosure of the invention is illustrative, but not limiting, and the scope of the invention is defined by the appended claims.

1. A user data backup method, comprising:
searching a local computer of a user for an editable document;
according to a search result, marking the editable document as data with backup requirement; and
backing up the data with backup requirement in a storage device on a network side.

2. The method according to claim 1, wherein said searching a local computer of a user for an editable document comprises:
searching a local computer of a user for a specific type of editable document.

3. The method according to claim 1, wherein said marking the editable document as data with backup requirement comprises one or more of the following three ways:
marking an editable document of a document size more than a preset threshold as data with backup requirement;
monitoring whether the size or modification time of a document has been changed, and if it has been changed, marking the document as data with backup requirement; and
monitoring the frequency of opening a document by the user, and if the frequency is greater than a preset threshold, marking the document as data with backup requirement.

4. The method according to claim 1, wherein said backing up the data with backup requirement in a storage device on a network side comprises:
backing up different versions of an editable document in a storage device on a network side, respectively, according to the editing time; or
backing up only a final version of an editable document in a storage device on a network side.

5.-10. (canceled)

11. A user data backup method, comprising:
monitoring a removable storage device connection status of a local computer of a user;
if it is monitored that a removable storage device is connected to the local computer, marking data in the removable storage device as data with backup requirement; and
backing up the data with backup requirement in a storage device on a network side.

12. The method according to claim 11, wherein said marking data in the removable storage device as data with backup requirement comprises one or more of the following three ways:
marking data located at a specific storage position in the removable storage device as data with backup requirement;
marking data of a specific type in the removable storage device as data with backup requirement; and
marking an editable document, an image document and/or a recording document in the removable storage device as data with backup requirement.

13.-16. (canceled)

17. A user data backup method, comprising:
monitoring a resource class temporary file generated in a local system;
backing up the resource class temporary file in a storage device on a network side; and
providing the local system with download of the backed-up resource class temporary file according to an access requirement of the local system.

18. The method according to claim 17, wherein
said backing up the resource class temporary file in a storage device on a network side comprises: uploading the resource class temporary file to a storage device on a network side; and
said providing the local system with download of the backed-up resource class temporary file according to an access requirement of the local system comprises: providing the local system with download of the uploaded resource class temporary file according to an access requirement of the local system.

19. The method according to claim 17, wherein the resource class temporary file comprises: a media file, an editable file and/or a web page cache file temporarily stored in the local system.

20. The method according to claim 17, wherein said monitoring a resource class temporary file generated in a local system comprises:
monitoring a specific temporary storage position in the local system and obtaining a resource class temporary file written to the temporary storage position; and/or
monitoring a startup behavior of a specific application and obtaining a resource class temporary file opened after the startup of the application.

21. The method according to claim 17, further comprising:
monitoring whether the temporary file has been modified, and if yes, uploading the modified file to the storage device on the network side.

22. The method according to claim 21, wherein said uploading the modified file to the storage device on the network side comprises:
uploading periodically different modified versions of the temporary file to the storage device on the network side respectively; or
uploading only a final modified version of the temporary file to the storage device on the network side.

23. The method according to claim 17, wherein the access requirement of the local system comprises:
access to a network address of the storage device on the network side by the local system, or
detection of a non-normal shutdown of the system or an application resulting from a failure of the local system.

24. The method according to claim 17, wherein said providing the local system with download of the uploaded resource class temporary file comprises:
providing the local system with download of the uploaded resource class temporary file after confirming the access right of the local system.

25.-34. (canceled)
